(19) United States
(12) Patent Application Publication
(10) Pub. No.: US 2006/0108000 A1
(43) Pub. Date: May 25, 2006

(54) Fuel cut off valve

(75) Inventors: Kenichiro Kaneko, Aichi-ken (JP); Hiroshi Nishi, Aichi-ken (JP); Hiroaki Kito, Aichi-ken (JP); Toshiyuki Sakurai, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/281,938

(22) Filed: Nov. 18, 2005

(30) Foreign Application Priority Data
Nov. 24, 2004 (JP) 2004-338574
Jan. 31, 2005 (JP) 2005-022400
Jul. 29, 2005 (JP) 2005-220476

(51) Int. Cl. F16K 24/04

(52) U.S. Cl. 137/202

(57) ABSTRACT

The fuel cut off valve comprises a casing, a float that rises and falls with increases and decreases in the buoyant force depending on the fuel liquid level within a valve chamber, and a valve mechanism that opens and closes a connecting passage through the rising or falling of the float, equipped on the upper part of the float. The valve mechanism comprises a supported part, and when the supported part is supported by a support part of the float, the center of gravity is provided below the support portion, so that the supported part is balanced on a single support portion. The fuel cut off valve can provide excellent seal performance when a vehicle is at an angle, and that can be miniaturized.

This application claims the benefit of and priority from Japanese Applications No. 2004-338574 filed Nov. 24, 2004, No. 2005-22400 filed Jan. 31, 2005 and No. 2005220476 filed Sep. 29, 2005, the contents of which are incorporated herein by reference.

### BACKGROUND OF THE INVENTION

1. Field of the Invention

The present invention relates to a fuel cutoff valve mounted on an upper wall of a fuel tank to open and close a connection passage, which connects the inside of the fuel tank with the outside.

2. Description of the Related Art

A conventional fuel cutoff valve is described in JP-A-7-279789. The fuel cut off valve is mounted on the upper part of a fuel tank and comprises a casing, which has a connecting passage for connection to a canister, a float, which rises and falls with increasing or decreasing buoyant force due to a level of the liquid fuel in the valve chamber of the casing, and a upper valve unit disposed at the upper part of the float. The fuel is prevented from flowing to the outside through the closure of the connecting passage by the upper valve unit, which is integrated with the float, moving upwards due to the float increasing the buoyant force when the level of the fuel in the fuel tank rises.

The upper valve unit is a flat plate valve body, and is disposed, at the center part thereof, on a conical protrusion, which is disposed on the upper part of the float, so as to be supported on the upper part of the float. This structure causes the seal part of the connecting passage to seat with the upper valve unit being inclined on the conical protruding part when the float is inclined due to the angle of the vehicle, or the like, and so is a structure that improves the seal performance through the upper valve unit maintaining its horizontal orientation, regardless of the orientation of the float.

However, there is a tendency for the upper valve unit to be supported in a state wherein the valve unit is off-center relative to the protrusion of the float. Because of this, the positioning of the upper part main unit is not stable, leading to a problem with reduced seal performance due to the upper valve unit being off-center in the seal part of the connecting passage. Additionally, there has been a problem in that the floats have tended to be large due to the need for increasing the upwards force of the float in order to close from a state wherein the upper valve unit is off-center.

Given this, as a structure for solving this problem, a fuel cut off valve has been disclosed wherein a float and a upper valve unit disposed at the upper part of the float are provided, where an recessed part of the upper valve unit is swivelably supported on a protruding part on the upper part of the float so as to maintain the horizontal orientation of the upper part unit even if the float is inclined as descried in U.S. Pat. No. 6,758,235, however, the fuel cut off valve has poor reopening performance in a full fuel control valve, where the connecting passage is large.

### SUMMARY

An advantage of some aspects of the invention is to provide a fuel cut off valve that is able to provide excellent sealing property, even when the vehicle is inclined, with a miniaturized fuel cut off valve.

According to an aspect of the invention, a fuel cut off valve is to be mounted on an upper portion of a fuel tank, for opening and closing a connecting passage that connects between an inside of the fuel tank and outside. The fuel cut off valve comprising: a casing that forms a valve chamber that connects the inside of the fuel tank and the connecting passage; and a float mechanism that is housed in the valve chamber and includes (i) a float that rises and falls by varying buoyant force according to a fuel level in the valve chamber and (ii) a valve mechanism that is disposed above an upper portion of the float and opens and closes the connecting passage through rising and falling of the float. The float includes a support part that is protruded from the upper portion of the float, the support part supporting the valve mechanism. The valve mechanism includes a supported part that is formed in a recess shape and supported on the support part, the valve mechanism being configured such that a center of gravity of the valve mechanism is set below a support portion where the support part supports the supported part under a balance.

The valve mechanism further includes a first valve unit having (i) a first valve main body, which has a first seat part that opens and closes the connecting passage and (ii) a connecting hole that is formed to pass through the first valve main body, an area of the connecting hole being smaller than that of the connecting passage; and a second valve unit having (i) a second valve main body that is interposed between the first valve unit and the upper portion of the float and (ii) a second seat part that is disposed on the upper part of the second valve main body and opens and closes the connecting hole, a lower part of the second valve main body being configured to have the supported part.

When fuel is supplied to a fuel tank that uses the fuel cut off valve according to the present invention and reaches a predetermined liquid level in the fuel tank, the fuel that flows into the valve chamber not only causes the float to rise due to buoyant force, but also causes the valve mechanism, which is integrated with the float, to rise. The rising of the float mechanism closes the connecting passage, thereby cutting off the fuel tank from the outside and preventing the fuel from flowing out from the fuel tank.

In the valve mechanism, the orientation of the valve mechanism is stabilized by achieving a balance, centered on the support portion, due to the valve mechanism being support firmly on a single support portion, by a supported part with an recessed shape on a protruding support part equipped on the upper part of a float, and by the center of gravity of the valve mechanism being positioned below the support portion. Consequently, even if the float is inclined, due to the vehicle being at an angle, the valve mechanism can attain excellent sealing property through the valve mechanism being maintained in a stabilized horizontal orientation and being reliably applied to, or removed from, the seal part of the connecting passage. Note additionally, that the structure with a protruding support part and an recessed supported part enables the reliable centering of the valve mechanism and the float, and facilitates the center of gravity being disposed below the support portion, enabling the orientation of the valve to be all the more stable.

Furthermore, the valve mechanism according to the present invention can obtain excellent reopening valve performance because the connecting passage is opened quickly due to reducing pressing force in the valve-closing direction that is applied to the first valve unit because a connecting hole, which has a passage area that is less than that of the connecting passage, is opened first by a second valve unit when opening the connecting passage.

Furthermore, as an alternative from, the first valve main body is formed from a resin material, and the seat member is made from a rubber material, enabling the structuring to be integrated with the first valve main body through insert molding. This structure enables the sealing property to be improved through increasing the sealing property between the first valve main body and the second valve unit.

Furthermore, as a preferred form of embodiment according to the present invention, the first valve main body so as to be provided with a supporting hole that connects to the connecting hole, where the second valve main body is housed, so as to be able to rise and fall, within the supporting hole, and a guide rib, which guides the second valve main body, so as to be able to rise and fall, is provided between the outer peripheral part of the second valve main body and the inside wall of the supporting hole. Given the structure, the fuel vapors that accumulate in the space at the upper part of the fuel tank will enter into the valve chamber of the supporting hole of the first valve unit as the position of the surface of the fuel rises when fuel is supplied, but will escape through the supporting hole and the gap with the outer peripheral surface of the second valve unit, and then through a ventilation hole. Consequently, the flow of the rising vapor that flows into the supporting hole escapes the outside through a connecting passage from the valve chamber, through a ventilation hole, rather than accumulating at the upper part of the supporting hole. Because of this, there is no localized increase in pressure in the supporting hole, and thus no force is applied so as to separate the second valve unit from the first valve unit. Furthermore, the guide rib of the second valve main body is supported on the inside wall of the supporting hole so as to guide the second valve unit relative to the first valve unit, without being at an angle. Consequently, the second valve unit will not be at an angle when rising or falling, so that the second seat part will seat with excellent sealing property in the connecting hole, so that there will be no problems that accompany a loss of sealing property between the second seat part and the seal part, or, in other words, no problems with the flow of fuel through the gap and through the connecting passage to the outside.

Moreover, in a modification of the embodiment, the structure may be such that the float comprises a first float part, which comprises the support part, and a second float part that is integrated with the first float part, structures so as to form a spring housing gap between the first float part and the second float part in the direction of the rising and falling, with the spring, which is supported on one end by a spring support part, disposed in the spring housing gap. In the structure, the buoyant force can be increased by a structure with a plurality of members comprising these first float parts and second float parts, or in other words, by the volume of a second float part wherein the first float part, which has the valve part, is integrated with the second float part. Moreover, the first float part need not be given thick cup-shaped walls in order to increase the buoyant force, and when forming it through injection molding, surface sink in the valve part etc. of the first float part can be reduced, so as to be able to increase the molding precision. Furthermore, the float can be a combination of a second float part that is integrated with a first float part, in order to increase the buoyant force, to reduce or eliminate the volume of the housing chamber wherein vapors accumulate, thereby enabling a reduction in the variability of the valve-closed fuel liquid level through reducing the variability in the buoyant force of the float that accompanying variability in the temperature of the vapor within the housing chamber.

Moreover, when fabricating the float using resin injection molding, the first float part may be fabricated while paying special attention to the fabrication precision of, for example, the valve part, so as to avoid constraints when it comes to the position of the cooling means. Moreover, for the second float part, one may emphasize primarily the shape for increasing the buoyant force and for disposing the spring, or in other words, need not have a shape that requires lengthy cooling times for both members. This shortens the injection molding fabrication cycle time, which is superior in terms of productivity.

Furthermore, in regards to the space for the disposition of the spring, the provision of the spring housing gap between the first float part and the second float part not only simplifies the disposition structure, but also eliminates the need for a large volume for varying the buoyancy of the float according to the variability in temperature.

As a preferred form of embodiment according to the present invention, the spring housing gap may be structured in one part of the outer peripheral part of the housing chamber, connected to the outside of the float through a ventilation hole that is fabricated so as to pass through the first float part. The structure does not cause variability in the valve-closed fluid level, because there is no variability in the apparent volume of the float, because even if the fuel rises into the spring housing gap due to capillary action, it is immediately expelled from the spring housing gap.

Another preferred form of embodiment can assume a structure wherein a spring, which applies a force to the second valve unit, in a valve-closing direction is disposed between the upper part of the float and a second valve unit. Given the structure, the effect will be that it will be difficult for the second valve unit to separate from the second seat part, so that even if small vibrations, caused by vibrations in the vehicle, or the like, reach the fuel cut off valve, the second valve unit will not open.

Moreover, another form of embodiment can be structured with the support part being structured separately from the float, with the spring being supported on the upper part of the float, and being disposed so as to provide a force on the support part in the valve-closing direction.

Preferred forms of embodiment according to the present invention will be explained below in order to provide a greater understanding of the structures and operation of the present invention, described above.

### BRIEF DESCRIPTION OF THE DRAWINGS

FIG. 1 is a cross-sectional view illustrating a fuel cut off valve attached to the upper part of a fuel tank of an automobile, according to a first embodiment according to the present invention.

FIG. 2 is a cross-sectional exploded view of the fuel cut off valve.

FIG. 3 is a prospective view showing the assembly of the float, the first valve unit, and the second valve unit.

FIG. 4 shows the action of the float mechanism.

FIG. 5 shows the action of the fuel cut off valve.

FIG. 6 shows the action, continuing from FIG. 5.

FIG. 7 is a cross-sectional view illustrating the vicinity of the valve mechanism of a fuel cut off valve according to a second embodiment.

FIG. 8 is a cross-sectional view according to a third embodiment.

FIG. 9 is a prospective view illustrating the first valve unit and the second valve unit according to a third embodiment according to the present invention.

FIG. 10 is a cross-sectional view illustrating a fuel cut off valve according to a fourth embodiment.

FIG. 11 is a cross-sectional view of the fuel cut off valve.

FIG. 12 is a prospective view illustrating the assembly of the float, the first valve unit, and the second valve unit, which structure of the valve mechanism.

FIG. 13 is a cross-sectional view of the assembly of the valve mechanism.

FIG. 14 shows the action of the float mechanism.

FIG. 15 shows the action of the fuel cut off valve.

FIG. 16 shows the action, continuing from FIG. 15.

FIG. 17 shows the action of the fuel cut off valve.

FIG. 18 is a cross-sectional view illustrating a fuel cut off valve according to a fifth embodiment.

FIG. 19 is a prospective assembly view wherein a portion of the float mechanism is cut away.

FIG. 20 is a cross-sectional view illustrating a sixth embodiment.

FIG. 21 is a cross-sectional view illustrating a modification of a fuel cut off valve according to a seventh embodiment.

FIG. 22 is a cross-sectional view illustrating a valve mechanism of a fuel cut off valve according to an eighth embodiment.

FIG. 23 is a cross-sectional view illustrating a valve mechanism of a fuel cut off valve according to a ninth embodiment.

FIG. 24 is a cross-sectional view illustrating a valve mechanism of a fuel cut off valve according to a tenth embodiment.

### DESCRIPTION OF THE PREFERRED EMBODIMENTS

### A. First Embodiment

(1) Schematic Structure of the Fuel Cut off Valve 10

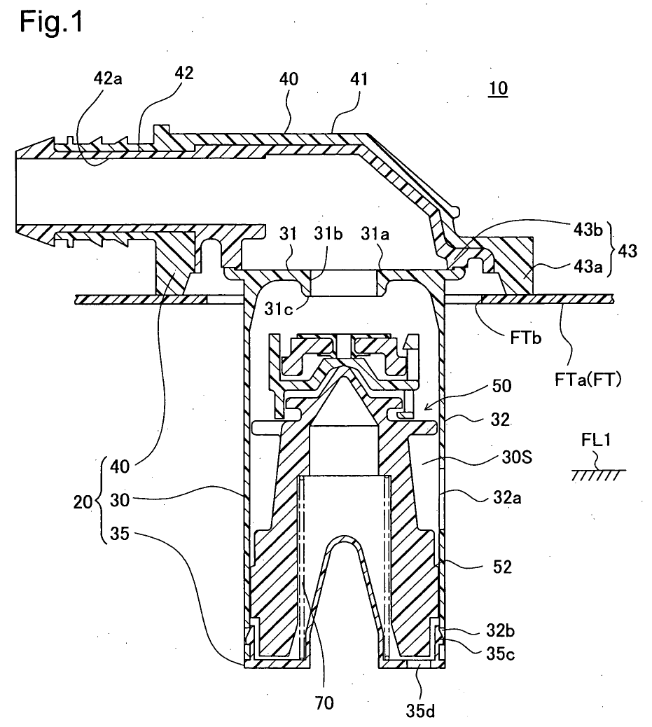

FIG. 1 is a cross-sectional view illustrating a fuel cut off valve 10, attached to the upper part of a fuel tank (FT) in a vehicle, according to a first embodiment according to the present invention. In FIG. 1, the fuel tank FT is formed with the surface thereof made of a compound resin material that includes polyethylene. A tank upper wall FTa of the fuel tank FT is formed with a attachment hole FTb. A fuel cut off valve 10 is attached to the tank upper wall FTa, with the lower part of the fuel cut off valve 10 inserted into the attachment hole FTb. When the level of a liquid fuel in the fuel tank FT rises to a predetermined liquid level FL1 by a supply of fuel, the fuel cutoff valve 10 prevents the fuel from flowing out to a canister (not shown).

(2) Structure of Each Part of the Fuel Cut off Valve 10

The fuel cut off valve 10 comprises, as the primary structure thereof, a casing 20, a float mechanism 50, and a spring 70. The casing 20 comprises a casing main body 30, a bottom plate 35, and a cover 40, where the space surrounding the casing main body 30 and the bottom plate 35 forms a valve chamber 30S, where the float mechanism 50, supported on the spring 70, is housed in the valve chamber 30S.

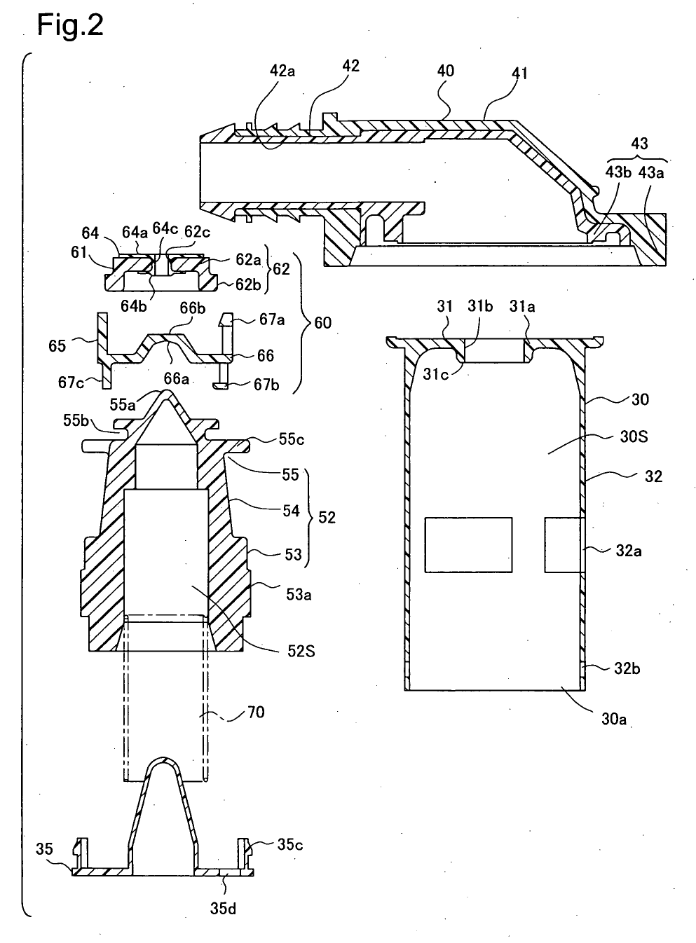

FIG. 2 is a cross-sectional view of an assembly of the fuel cut off valve 10. The casing main body 30 is a cup shape that is surrounded by a top wall 31 and a sidewall 32, the bottom part of the casing main body 30 is an opening 30a. A passage formation projection 31a is fabricated, facing downward, in the center part of the top wall 31, where the passage formation projection 31a is fabricated with a connecting passage 31b, which connects the valve chamber 30S and a cover side passage 42a, passing there through. A seal part 31c is formed on the valve chamber 30S side of the connecting passage 31b. A first through hole 32a, which connects the inside of the fuel tank FT to the valve chamber 30S, is formed in the sidewall 32, and engaging claws 32b, for attaching the bottom plate 35, is formed in the sidewall 32.

The bottom plate 35 is a member for closing the opening 30a of the casing main body 30, and by mating engaging claws 35c, formed around the outer peripheral part thereof, to the mating holes 32b of the casing main body 30, the bottom plate 35 is attached so as to close the opening part 30a of the casing main body 30. A second through hole 35d, which connects the valve chamber 30S and the inside of the fuel tank FT, is formed in the bottom plate 35. Consequently, the inside of the fuel tank FT is connected to the valve chamber 30S through the second through hole 35d.

The cover 40 comprises a cover main body 41, a tubular body 42 that protrudes towards the side from the center of the cover main body 41, and a flange 43 that is formed around the outer peripheral of the cover main body 41, where these are integrally formed. A cover side passage 42a is fabricated in the cylindrical part 42, where an end of the cover side passage 42a is connected to the valve chamber 30S of the casing main body 30, through the connecting passage 31b, and the other end is connected to the canister that is not shown. An inside welded end 43b, which is welded to the top end of the casing main body 30, is formed at the bottom of the cover main body 41. An outside welding part 43a, which is welded to the tank upper wall FTa of the fuel tank FT, is formed on the bottom end of the flange 43.

The float mechanism 50 comprises a float 52 and a valve mechanism 60, which is disposed at the upper part of the float 52. The float 52 has a buoyancy chamber 52S, which is open towards the bottom, a large diameter part 53, a reduced diameter part 54, wherein the diameter is reduced from that of the upper part of the large diameter part 53, and a valve support part 55, fabricated on the upper part of the reduced diameter part 54, where these parts are integrally formed. The float 52 is supported by the spring 70, which spans between the bottom plate 35 and the top surface of the buoyancy chamber 52S.

The outer peripheral part of the large diameter part 53 is equipped with four guide ribs 53a for guiding, in the vertical direction, the float 52. Each of the guide ribs 53a is equipped in the vertical direction at an interval around the sidewall of the large diameter part 53.

The valve support part 55 is a part that supports the valve mechanism 60 swivelably, and comprises a support part 55a, which is an essentially conical protrusion (protruding shape). The outer peripheral part of the valve support part 55 is equipped with a mating recess 55b, for preventing the valve mechanism 60 from coming out. Guide parts 55c are disposed within the outer peripheral part of the valve support part 55. Each of the guide parts 55c is a rod shape and is disposed protruding in the circumferential direction in a cross centering on the float 52, where the end of the guide part 55c is guided on the inside wall of the sidewall 32.

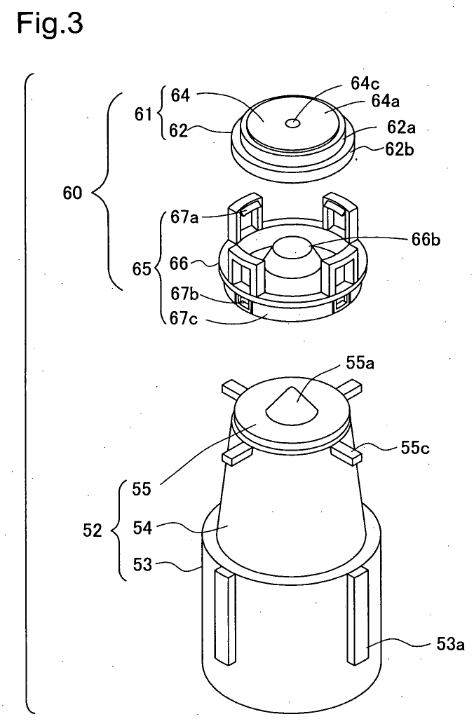

The valve mechanism 60 is a valve for opening and closing the connecting passage 31b and for improving the reopening performance, and is supported swivelably and in such a fashion as to rise and fall, on the valve support part 55 of the float 52. FIG. 3 is a prospective view showing the assembly of the float 52 and the first valve unit 61 and second valve unit 65 that structure the valve mechanism 60. The first valve unit 61 comprises a first valve main body 62, which has a disk part 62a and a peripheral step part 62b that is equipped extending in the downwards direction from the outer peripheral part of the disk part 62a, and a seat member 64, attached to the first valve unit 61. As shown in FIG. 2, a through hole 62c is formed in the center of the disk part 62a. The seat member 64 is formed from a rubber material and covers the wall surfaces of the through hole 62c, and a part of the bottom surface and the top surface of the first valve main body 62, and comprises a first seat part 64a attached and detached to the seal part 31c, a seal part 64b and a connecting hole 64c that is formed by covering a first seat part 64a.

The seat member 64 is integrated with the first valve main body 62 through the manufacturing process described below. In other words, the first valve main body 62 is fabricated with resin through injection molding. There after, an adhesive is coated onto the surface where the seat member 64 adheres to the first valve main body 62, the first valve main body 62 is placed in a mold as an insert member, and a rubber material is injected into the cavity. Along with vulcanizing the rubber material at approximately 200° C., the seat member 64 is integrated with the first valve main body 62 through vulcanization adhesion. Polyphenylene sulfide (PPS), which has the property of enduring the head to of the 200° C. vulcanization temperature is used as the resin material for the first valve main body 62. A fluorine rubber, a high saturation nitryl rubber or the like, can be used for the rubber material, and, in particular, a vinylidene fluoride-hexafluoropropylene copolymer (FKM) or a hydrogenated butadiene acrylonitryl rubber (HNBR) is preferable.

In FIG. 3, the second valve unit 65 comprises a second valve main body 66, top-part retaining claws 67a fabricated around the outer peripheral part of the second valve main body 66, lower part retaining claws 67b, equipped protruding downward from the bottom surface of the second valve main body 66, and an outer peripheral wall 67 equipped protruding downward from the second valve main body 66, where these are integrally formed. On the center bottom surface of the second valve main body 66, shown in FIG. 2, is formed a supported part 66a as recess, where the disposition of the supported part 66a on top of the support part 55a of the float 52 causes the second valve unit 65 to be supported using the support part 55a as the support portion. Moreover, in the center of the top surface of the second valve main body 66 is formed a second seat part 66b, where the second seat part 66b is formed so as to open and close the connecting hole 64c through pushing against, and being removed from, the seal part 64b. Furthermore, the upper part retaining claws 67a are formed protruding from the bottom surface of the outer periphery of the second valve main body 66, and are equipped protruding towards the inside of a hollow rectangular frame unit, where the first valve unit 61 is retained through mating with the peripheral edge step part 62b of the first valve unit 61. The lower part retaining claws 67b are equipped protruding from the outer peripheral bottom surface of the second valve main body 66 and are equipped protruding towards the inside of a hollow rectangular frame, and retain the second valve unit 65 on the float 52 through mating with the mating recess 55b of the float 52. Moreover, the center of gravity of the valve mechanism 60 is equipped below the supported part 66a. As the structure by which to achieve this, the outer peripheral wall 67c is fabricated so as to have a large gravity in the downwards direction between the lower part retaining claws 67b. Moreover, having the support part 55a be a protruding shape and the supported part 66a be an recessed part facilitates the centering of the valve mechanism 60 and the float 52, simplifying the disposition of the center of gravity below the support portion, thereby stabilizing the orientation of the valve mechanism 60.

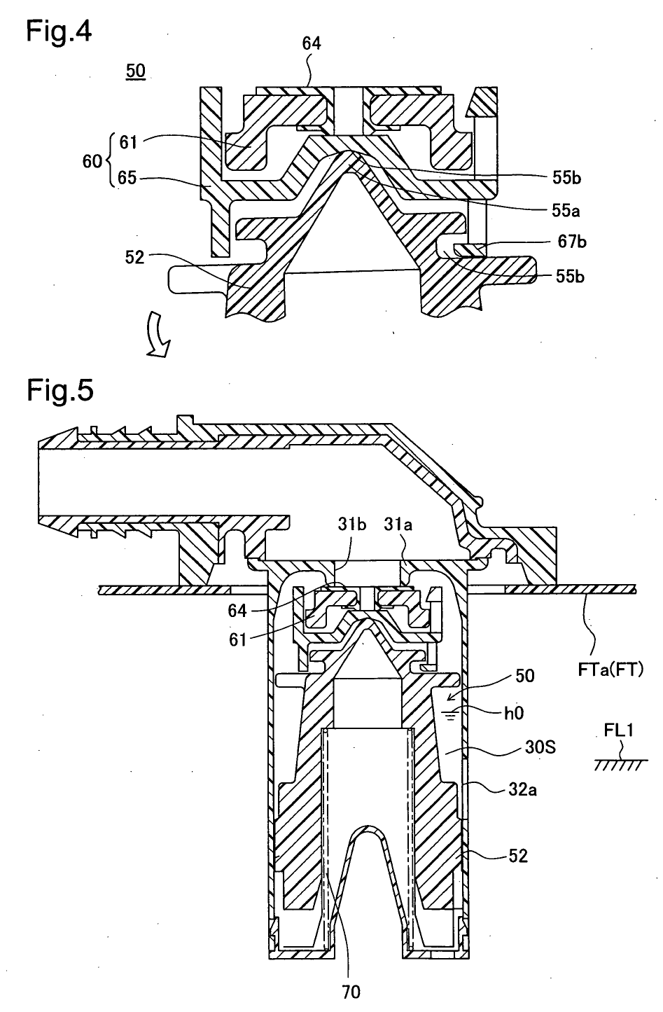

FIG. 4 shows the effect of the float mechanism 50. As shown in FIG. 4, if the float 52 is inclined in the direction of the arrow by, the inclination of the vehicle, the second valve unit 65 is held on the float 52 by the mating between the lower part retaining claws 67b and the mating recess 55b, and is supported on a single portion by the support part 55a of the float 52. This achieves a balance such as seen in a child's balancing toy, so that the seat member 64 of the first valve unit 61 is maintained in a horizontal orientation.

(3) Operations of the Fuel Cut off Valve 10

Next, the operation of the fuel cut off valve 10 will be explained. As shown in FIG. 1, when fuel is supplied into the fuel tank FT during fueling, the fuel vapors that have accumulated in the upper space of the fuel tank will pass through the second through hole 35d in the bottom plate 35 and the first through hole 32d in the sidewall 32 as the liquid level of the fuel within the fuel tank FT rises, to enter into the valve chamber 30S, and will escape toward the canister from the valve chamber 30S through the connecting passage 31b and the cover side passage 42a. Moreover, as shown in FIG. 5, when the liquid level of the fuel within the fuel tank FT reaches a predetermined liquid level FL1, the fuel blocks the first through hole 32a, causing the pressure in the fuel tank FT to rise. A sensor senses the increase of pressure in the tank, actuating the auto-stop that stops the fueling from the fuel supply gun. When in this state, there is a large pressure differential between the pressure in the tank and the pressure in the valve chamber 30S, causing the level of the surface of the fuel to rise into the valve chamber 30S. When the fuel level in the valve chamber 30S reaches the height h0, the force in the upwards direction due to the buoyant force of the float 52 and the loading of the spring 70, which is balanced with the downward force of the weight of the float mechanism 50, causes the float mechanism 50 to come together into a single unit because the former overbalances the later, causing the seat member 64 of the first valve unit 61 to seat against the seal part 31c, to close the connecting passage 31b. This enables the fuel vapors to escape from the fuel tank while preventing the fuel from flowing out of the fuel tank, during, for example, fueling into the fuel tank.

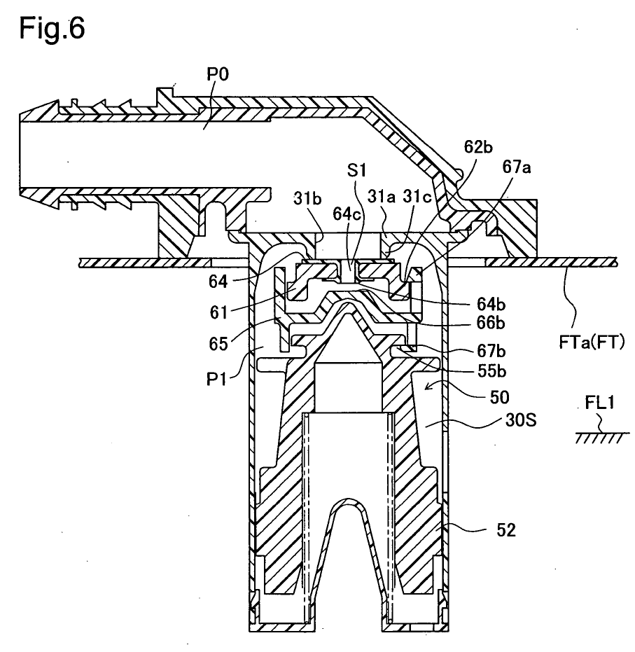

On the other hand, as the fuel within the fuel tank FT is consumed and the fuel level drops, then, as shown in FIG. 6, the float 52 falls as the buoyant force is reduced. The falling of the float 52 pulls the second valve unit 65 downward through the linkage between the lower part retaining claws 67b of the second valve unit 65 and the mating recess 55b of the float 52. As a result, the second seat part 66b separates from the seal part 64b, opening the connecting hole 64c. The pressure on the first valve unit 61 in the downward direction due to the connection of the connecting hole 64c is brought to essentially the same pressure as the vicinity of the connecting passage 31b, through the connecting hole 64c. Consequently, because the upper part retaining claws 67a mate with the peripheral edge step part 62b, the first valve unit 61 is pulled downwards via the second valve unit 65. Moreover, the downward motion of the first valve unit 61 separates the seat member 64 from the seal part 31c, opening the connecting passage 31b.

Here the reason it is possible to improve the reopening valve characteristics in the fuel cut off valve 10 will be explained. Defining the flow path area of the connecting hole 64c of the first valve unit 61 as S1, defining the tank-side pressure as P1, defining the canister-side pressure as P0, defining the spring load as K, and defining the total weight of the float 52 the second valve unit 65 as W, then when there are values that fulfill the equation (1), the second seat part 66b of the second valve unit 65 will transition from a state where in the valve is closed to a state where in the valve is open.
(P1−P0)S1≦W−K (1)

The right-hand side of Equation (1) is the difference between the weight W and to the spring load K, which is a positive value. That is, this is a force that is applied to the second valve unit 65 in the valve-opening direction, and when this is assumed to be constant, then the left-hand side is the force that is applied in the valve-closing direction, closing the second seat part 66b of the second valve unit 65 and applying section thereto. Here, when the flow path area S1 is small, the valve will open, even when there is a large pressure differential (P1−P0). In other words, if it is assumed that the canister-side pressure P0 is a constant, and even when there is a large tank-side pressure P1, the valve will open. Consequently, when the flow path area S1 of the connecting hole 64c is set to be smaller than the flow path area of the connecting passage 31b, then the second valve unit 65 will open with a small force from the seat member 64. In the way, the two-stage of valve structure, comprising the second valve unit 65 and the first valve unit 61, functions to promote an improvement in the reopening characteristics.

(4) Action and Effects of the Embodiment

The structures of the embodiment have the following actions and effects:

(4)-1: When the fuel level in the fuel tank exceeds a predetermined fuel level that blocks the first through hole 32a due to fueling, the internal tank pressure in the fuel tank FT increases, which can actuate an automatic cutoff.

(4)-2: The valve mechanism 60 is supported on a single support portion at the supported part 66a by the support part 55a, equipped at the upper part of a float 52, and the center of gravity of the valve mechanism 60 is positioned lower than the support portion, and thus a balance is achieved centered on the support portion, stabilizing the orientation of the valve mechanism 60. Consequently, even if the float 52 is inclined because the vehicle is at an angle, the valve mechanism 60 maintains a stable horizontal orientation, enabling reliable application to and removal from the seal part 31c of the connecting passage 31b, enabling the achievement of excellent sealing property.

(4)-3: The valve mechanism 60 automatically performs operations to stabilize the orientation using the same principles as a child's balancing toy, enabling the force that is applied against the seal part 31c, and enabling the buoyant force required in the float 52 to close the valve also to be small, enabling miniaturization.

(4)-4: The seat member 64 is integrated with the first valve main body 62, both enabling a simplification of the assembly works, and enabling excellent sealing property.

### B. Second Embodiment

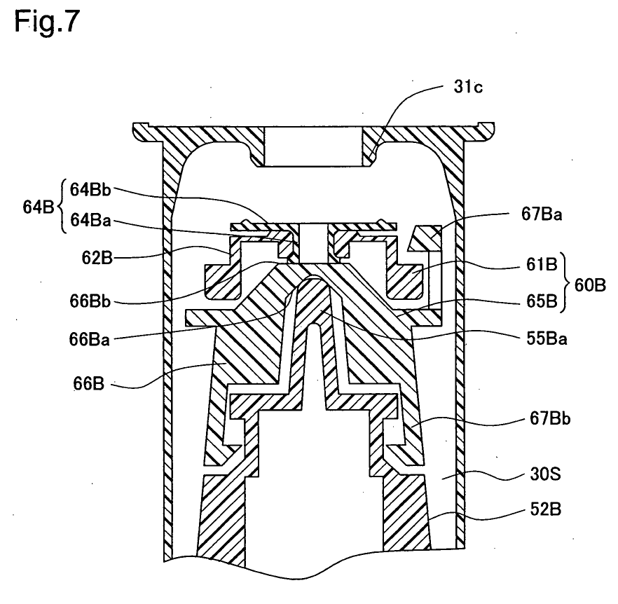

FIG. 7 is a cross-sectional view showing the vicinity of the valve mechanism 60B of a fuel cut off valve according to the second embodiment. The second embodiment has, as its primary distinctive feature, a structure that improve the valve reopening characteristics of the valve mechanism 60B. The valve mechanism 60B comprises a first valve unit 61B, and a second valve unit 65B, above the float 52B. A seat member 64B is provided on a first valve main body 62B of the first valve unit 61B. The seat member 64B comprises an attachment part 64Ba that is pressed fitted into the first valve main body 62B, and a disk part 64Bb that is formed at the upper part of the outer periphery of the attachment part 64Ba, where these parts are integrally formed from a rubber material. The disk part 64Bb has a gap from the top surface of the first valve main body 62B, which, when seated against the seal part 31c, increases the sealing property through plastic deformation. A second seat part 66Bb is formed on the top surface of the second valve main body 66B of the second valve unit 65B, and upper part retaining claws 67Ba, which retain the first valve unit 61B, and lower part retaining claws 67Bb, for holding against the float 52B, are fabricated, respectively, on the top and bottom parts of the outer periphery of the second valve main body 66B.

A supported part 66Bb is fabricated on the lower surface in the center of the second valve main body 66B. The supported part 66Bb is supported by a linear contact by the support part 55Ba of the float 52B. This support structure can reduce the contact surface pressure, increasing durability to, for example, wear.

### C. Third Embodiment

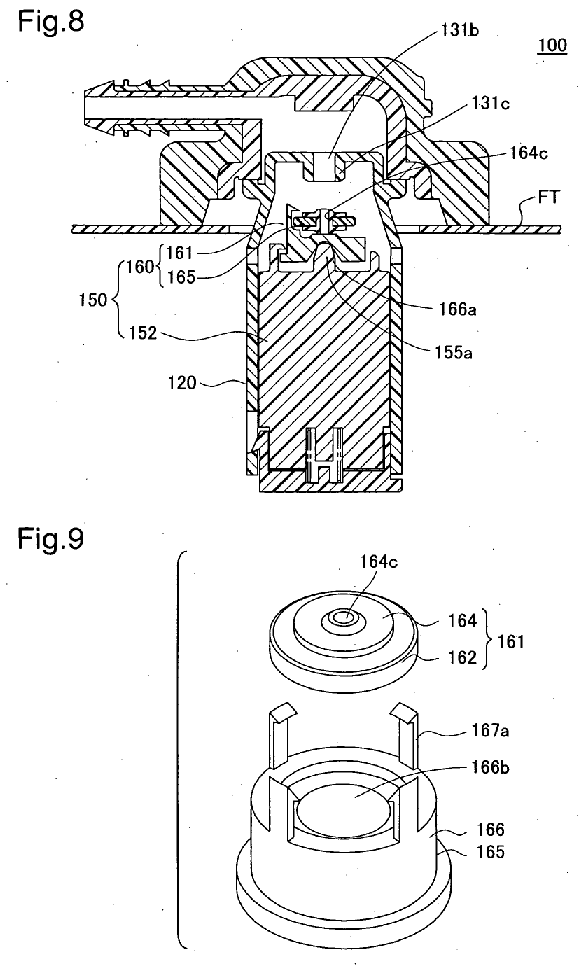

FIG. 8 is a cross-sectional view illustrating the fuel cut off valve according to a third embodiment. The third embodiment is a structure that is applied to a valve that prevents fuel from flowing out from a fuel tank when, for example, a vehicle is at an angle. A float mechanism 150 is housed within a casing 120, which has a connecting passage 131b within a fuel cut off valve 100. The float mechanism 150 comprises a valve mechanism 160, made from a first valve unit 161 and a second valve unit 165, and the top of a float 152. FIG. 9 is a prospective view of the assembly of the valve mechanism 160. In the first valve unit 161, a seat member 164 is integrated with a first valve main body 162, which has a connecting hole 164c. In the second valve unit 165, a second seat part 166b is fabricated in the center of the top surface of a second valve main body 166, and upper part retaining claws 167a, which hold the first valve unit 161, are fabricated on the upper part of the outer periphery of the second valve main body 166. As shown in FIG. 8, the valve mechanism 160 comprises a supported part 166a on the bottom surface in the center of the second valve main body 166, where the supported part 166a is supported at one location on a support part 155a of the float 152, and the center of gravity is set to be below the support portion.

In the structure of the fuel cut off valve 100, when the level of the fuel within the fuel tank FT rises due to fueling or due to the vehicle being at an angle, or the like, then as the float 152 rises, the seat member 164 of the first valve unit 161 seats against the seal part 131c to close the connecting passage 131b. On the other hand, as the fuel within the fuel tank is consumed, or as the inclination of the vehicle is resolved, causing the fuel level to fall, the float 152 moves downward as the buoyant force is reduced, and the second seat part 166b opens a connecting hole 164c, full of which the first valve unit 161 opens a connecting passage 131b.

Given the fuel cut off valve 100 according to the present embodiment, excellent sealing property can be obtained through reliably seating against the seal part 131c of the connecting passage 131b because the float 152 supports and balances the valve mechanism 161 a single location, even if the float 152 is at an angle due to, for example, the inclination of the vehicle.

### D. Fourth Embodiment

(1) Schematic Structure of a Fuel Cut off Valve 200

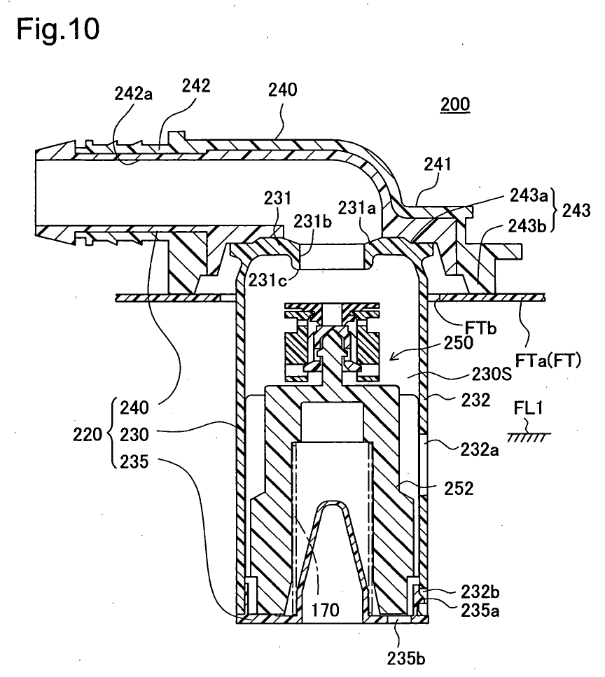

FIG. 10 is a cross-sectional view showing a fuel cut off valve 200 that is attached to the upper part of a fuel tank FT of a vehicle, according to one embodiment according to the present invention. In FIG. 10, the fuel tank FT is make of a compound resin material with polyethylene included in the surface thereof, where an attachment hole FTb is fabricated in the tank upper wall FTa. A fuel cut off valve 200 is attached in the tank upper wall FTa in a state wherein the lower part thereof is inserted into the attachment hole FTb. The fuel cut off valve 200 constraints the flow to a canister when the fuel within the fuel tank rises to a predetermined liquid level FL1 during fueling.

(2) Structure of Each Part of the Fuel Cut off Valve 200

The fuel cut off valve 200 comprises, as its primary structures, a casing 220, a float mechanism 250, and a spring 270. The casing 220 comprises a casing main body 230, a bottom plate 235, and a cover 240, where a space enclosed by the casing main body 230 and the bottom plate 235 forms a valve chamber 230S, where the float mechanism 250, which is a supported by the spring 270, is housed in the valve chamber 230S.

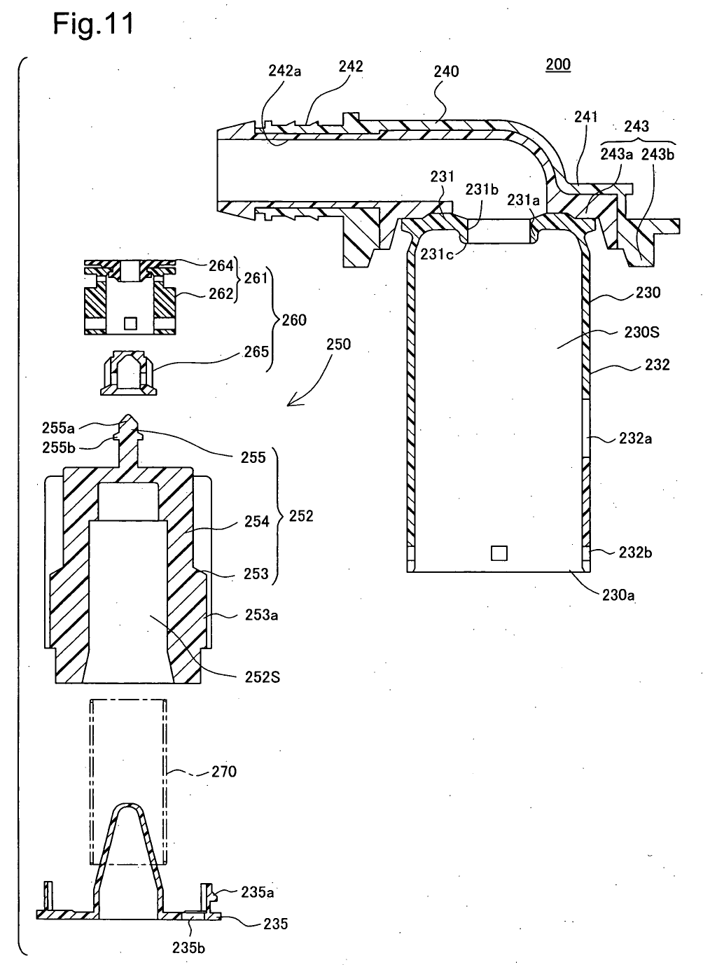

FIG. 11 is a cross-sectional view of the assembly of the fuel cut off valve 200. The casing main body 230 forms a top shape enclosed by a top wall 231 and a sidewall 232, with the bottom part thereof being an opening 230a. A protruding part 231a, for fabricating a passage, is equipped protruding in the downward direction in the center of the top wall 231, where a connecting passage 231b is fabricated passing through the protruding part 231a for forming a passage. The side of the valve chamber 230S of the connecting passage 231b is a seal part 231c. A first through hole 232a, which connects the inside of the fuel tank FT to the valve chamber 230S is formed in the sidewall 232, and mating holes 232b are formed for attaching a bottom plate 235.

The bottom plate 235 is a member that closes the opening 230c of the casing main body 230, and is attached so as to close the opening 230a of the casing main body 230 through mating the mating claws 235a a, formed on the outer peripheral part thereof, to the mating holes 232b of the casing main body 230. A second through hole 235b, which connects the valve chamber 230S to the inside of the fuel tank FT, is formed in the bottom plate 235. Consequently, the fuel tank FT is connected to the valve chamber 230S through the second through hole 235b.

The covering 240 comprises a covering main unit 241, a cylindrical part 242 that protrudes to the side from the center of the covering main unit 241, and a flange 243, formed around the outer periphery of the covering main unit 241, where these parts are integrally formed. A covering side passage 242a is formed on the cylindrical part 242, where one end of the covering side passage is connected to the valve chamber 230S of the casing main body 230 through the connecting passage 231b, and the other end is connected to the canister (the side not shown in the figure). An inside welding end 243a, to which the top and of the casing main body 230 is welded, is formed at the bottom part of the covering main unit 241, and an outside welding part 243b, which is welded to the tank upper wall FTa of the fuel tank FT, is formed on the bottom and part of the flange 243.

The float mechanism 250 comprises a valve mechanism 260, disposed at the top of a float 252. The float 252 has a buoyancy chamber 252S, which is open on the bottom, a large diameter part 253, a reduced diameter part 254, with a diameter that is reduced beyond that of the upper part of the large diameter part 253, and a valve support part 255, formed on the upper part of the reduced diameter part 254, all integrally formed. The float 252 is supported by a spring 270, spanning between the bottom plate 235 and the top surface of the buoyancy chamber 252S. Guide ribs 253a, for guiding the float 252 in the upwards and downwards directions, are provided on the outer periphery of the large diameter part 253 and the reduced diameter part 254, where the guide ribs 253a are provided protruding in rib shapes, in the upwards and downwards directions, in four locations, equally spaced around the periphery of these sidewalls.

The valve support part 255 comprises a support part 255a that is a that is an essentially conical protrusion, and is the part that supports the valve mechanism 260 swivelably. A ring-shaped protruding part 255b, for retaining the valve mechanism 260, is formed around the outer peripheral part of the valve support part 255.

The valve mechanism 260 is a valve for improving the valve reopening performance, along with being able to open and close the connecting passage 231b, and is supported on the valve support part 255 of the float 252 so as to be able to rise and fall and so as to be able to swivel. The valve mechanism 260 comprises a first valve unit 261 and a seat member 264, equipped on the first valve unit 261.

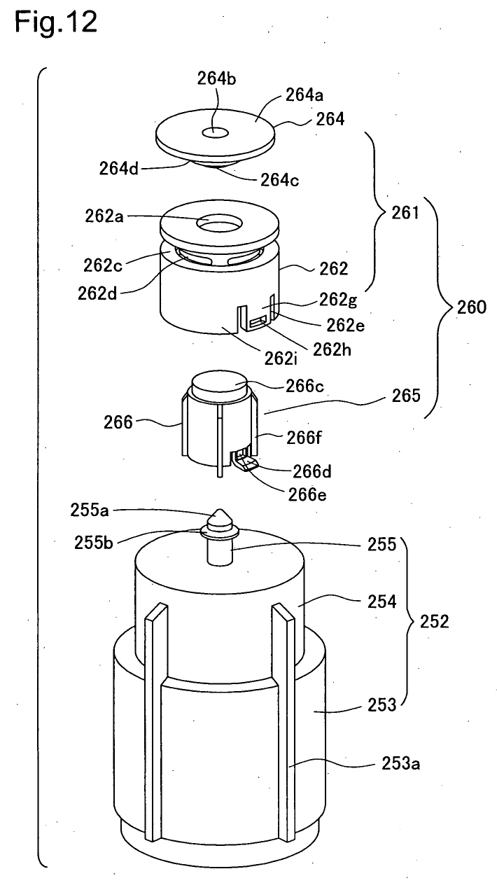

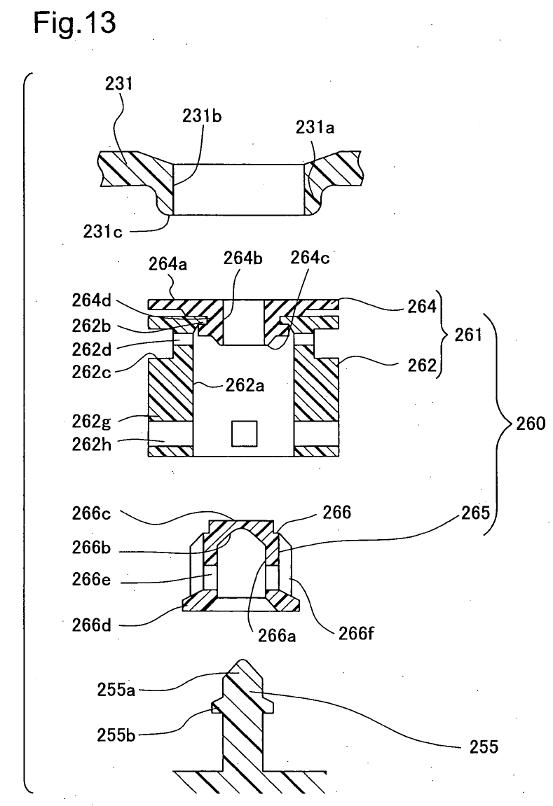

FIG. 12 is a prospective view showing the assembly of the first valve unit 261 and the second valve unit 265, which structure the valve mechanism 260, and FIG. 13 is a cross-sectional view showing the assembly of the valve mechanism 260. A first valve unit 261 is equipped with an essentially cylindrical first valve main body 262, where a supporting hole 262a is fabricated in the axial direction within the first valve main body 262. An attachment part 262b, for attaching the seat member 264, is fabricated at the upper part of the first valve main body 262. Moreover, a ring-shaped recessed part 262c is fabricated at the outer peripheral part of the first valve main body 262, where ventilation holes 262d, for connecting the supporting hole 262a to the outside, are fabricated in four locations of the ring-shaped recessed part 262c. As a shown in FIG. 12, a slit 262e is formed at the bottom part of the first valve main body 262, where a mating piece 262g is made from a fastening piece 262i is fabricated from the slit 262e so as to be elastically deformable. A mating hole 262h is formed in the mating piece 262g.

The seat member 264 comprises a first seat part 264a, which is pushed against and remove from the seal part 231c, a connecting hole 264b, which connects to the supporting hole 262c, a seal part 264c, which is formed on the bottom edge of the connecting hole 264b, and attachment part 264d, where these are integrally formed from a rubber material. The seat number 264 is equipped on the attachment part 262d of the first valve main body 262 by the attachment part 264d, where the first seat part 264a having a gap relative to the top surface of the first valve main body 262 increases the sealing property through elastic deformation when seating on the seal part 231c.

In FIG. 13, the second valve unit 265 comprises a cylindrical second valve main body 266. A hole 266a with a bottom which has an opening in the downward direction, is formed in the second valve main body 266, where a supported part 266b, which has an recessed shape, is formed in the center of the bottom of the hole with a hole 266a. The supported part 266b is placed on the support part 255a of the float 252 so that the second valve unit 265 is supported swivelably using the support part 255a as the support portion.

Furthermore, a second seat part 266c is formed on the top surface of the second valve main body 266, where the second seat part 266c is formed so as to be able to open and close the connecting hole 264b through being pushed against and removed from the seal part 264c of the first valve unit 261. Retaining claws 266c are formed in two locations on the bottom part of the second valve main body 266, and mated to the mating holes 262h of the first valve main body 262 to support the first valve unit 261 so as to be able to rise relative to the second valve unit 255. A mating hole is formed at the upper part of each of the retaining claws 266d, and mate with the ring-shaped protruding part 255b of the float 252 so that the second valve unit 255 is supported and retained so as to be able to rise relative to the float 252. Furthermore, guide ribs 266f, for guiding the second valve unit 265 in the upwards and downwards directions are formed on the outer peripheral part of the second valve main body 266. The guide ribs. 266f are formed in ribs shapes, in the upwards and downwards directions, protruding in four locations that are equally spaced in the peripheral direction of the sidewall of the second valve main body 266, and can slide freely on the inner wall surface of the ring-shaped recess 262c.

In addition, the center of gravity of the valve mechanism 260 is provided below the supported part 266b. As a structure to do so, the valve mechanism 260 has the attachment piece 262i that increases the gravity in the downward direction. Moreover, the support part 255a having a protruding shape and the supported part 266b having an recessed part facilitates the centering of the valve mechanism 260 and the float 252, and facilitates the provision of the center of gravity below the support portion, stabilizing also the orientation of the valve mechanism 260.

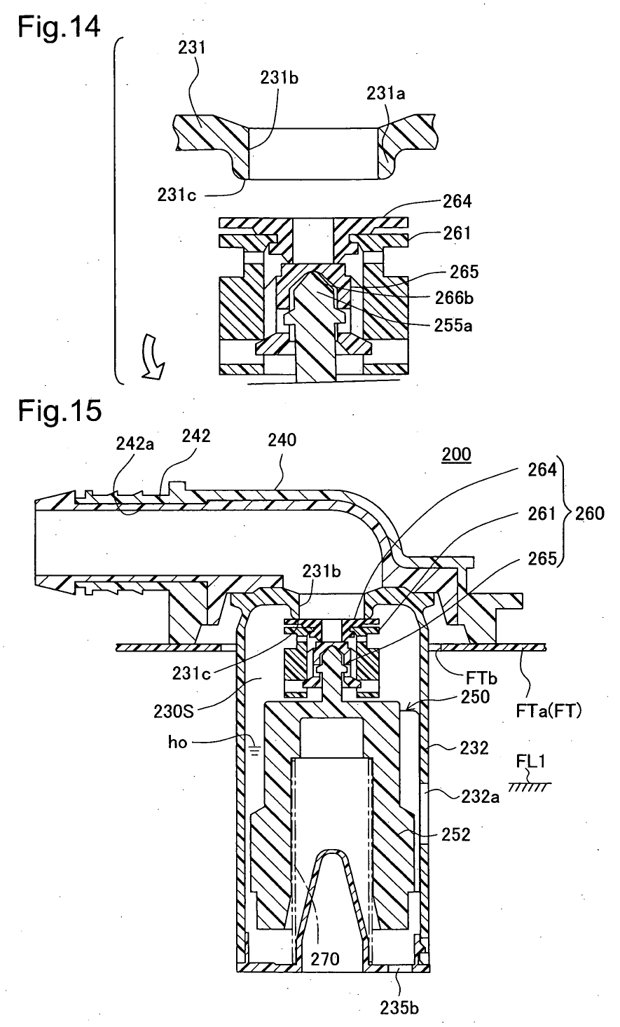

FIG. 14 is an explanatory view for explaining the action of the float mechanism 250. As shown in FIG. 14, the float 252 is inclined in the direction of the arrow through, for example, the vehicle being at an angle. In the second valve unit 265, the supported part 266b is supported by a single portion by the support part 255a of the float 252, and thus a balance is achieved in the same manner as in a child's balancing toy, so that the seat member 264 of the first valve unit 261 maintains a horizontal orientation.

(3) Operations of the Fuel Cut off Valve 200

Next, the operation of the fuel cut off valve 200 will be explained. As shown in FIG. 10, when fuel is supplied into the fuel tank FT during fueling, the fuel vapors that have accumulated in the upper part of the fuel tank will pass through the second through hole 235b in the bottom plate 235 and the first through hole 232a in the sidewall 232 as the surface level of the fuel within the fuel tank FT rises, to enter into the valve chamber 230S, and will escape to the canister side from the valve chamber 230S through the connecting passage 231b and the cover side passage 242a. Moreover, as shown in FIG. 15, when the level of the surface of the fuel within the fuel tank FT reaches a predetermined liquid level FL1, the fuel blocks the first through hole 232a, causing the pressure in the fuel tank FT to rise. A sensor senses the increase of pressure in the tank, actuating the auto-stop that stops the fueling from the fuel supply gun. When in the state, there is a large pressure differential between the pressure in the tank and the pressure in the valve chamber 230S, causing the level of the surface of the fuel to rise into the valve chamber 230S. When the fuel level in the valve chamber 230S reaches the height h0, the force in the upwards direction due to the buoyant force of the float 252 and the loading of the spring 270, which is balanced with the downward force of the weight of the float mechanism 250, causes the float mechanism 250 to come together into a single unit because the former overbalances the later, causing the seat member 264 of the first valve unit 261 to seat against the seal part 231c, to close the connecting passage 231b. This enables the fuel vapors to escape from the fuel tank while preventing the fuel from flowing out of the fuel tank, during, for example, fueling into the fuel tank.

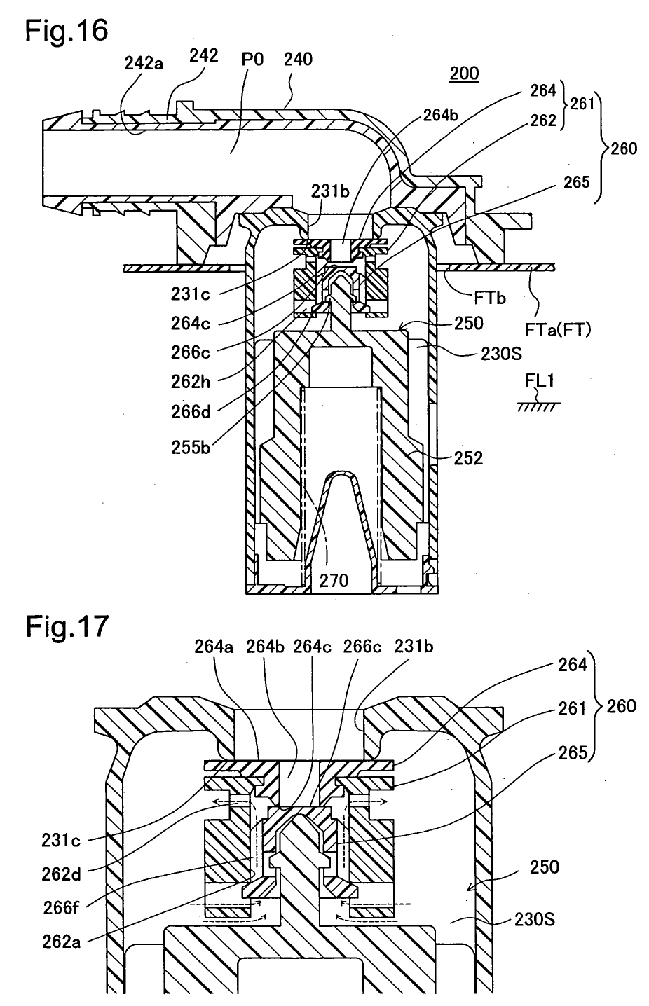

On the other hand, as the fuel within the fuel tank FT is consumed and the fuel level drops, then, as shown in FIG. 16, the float 252 falls as the buoyant force is reduced. The falling of the float 252 pulls the second valve unit 265 downward through the linkage between the retaining claws 266d of the second valve unit 265 and the ring-shaped protruding part 255b of the float 252. As a result, the second seat part 266b separates from the seal part 264c, opening the connecting hole 264b. The pressure on the first valve unit 261 in the downward direction due to the connection of the connecting hole 264b is brought to essentially the same pressure as the vicinity of the connecting passage 231b. Consequently, because the upper part retaining claws 266d mate with the mating hole 262h, the first valve unit 261 is pulled downwards via the second valve unit 265. Moreover, the downward motion of the first valve unit 261 separates the seat member 264 from the seal part 231c, opening the connecting passage 231b.

(4) Action and Effects of the Embodiment

The structures of the embodiment have the following actions and effects:

(4)-1: When the fuel level in the fuel tank exceeds a predetermined fuel level that blocks the first through hole 232a due to fueling, the internal tank pressure in the fuel tank FT increases, which can actuate an automatic cutoff.

(4)-2: The valve mechanism 260 is supported on a single support portion at the supported part 266b by the supported part 255a, equipped at the upper part of a float 252, and the center of gravity of the valve mechanism 260 is positioned lower than the support portion, and thus a balance is achieved centered on the support portion, stabilizing the orientation of the valve mechanism 260. Consequently, even if the float 252 is inclined because the vehicle is at an angle, the valve mechanism 60 maintains a stable horizontal orientation, enabling reliable application to and removal from the seal part 231c of the connecting passage 231b, enabling the achievement of excellent sealing property.

(4)-3: The valve mechanism 260 automatically performs operations to stabilize the orientation using the same principles as a child's balancing toy, enabling the force that is applied against the seal part 231c, and enabling the buoyant force required in the float 252 to close the valve also to be small, enabling miniaturization.

(4)-4: As shown in FIG. 17, the fuel vapors that have a simulated within the space at the upper part of the fuel tank have an upward vapor flow within the valve chamber 230S accompanying the rise of the fuel level during fueling, and so enter into the supporting hole 262a of the first valve unit 261, but escape from the ventilation hole 262d through the gap between the supporting hole 262a and the guide ribs 266f. Consequently, the upward vapor flow that flows through the supporting hole 262a does not accumulate at the upper part of the supporting hole 262a, but rather escapes through the ventilation hole 262d. Because of this, the pressure is not become locally by within the supporting hole 262a so as to apply a force so as to pull off the second valve unit 265 from the first valve unit 261. Furthermore, the guide ribs 266f of the second valve main body 266 are supported on the inside wall of the supporting hole 262a, and guide to the second valve unit 265 relative to the first valve unit 261, without inclining the second valve unit 265. Consequently, the second valve unit 265 does not incline when rising and falling, and so the second seat part 266c seats onto the seal part 264c with excellent sealing property, and there are no problems with a repassageion in sealing property therebetween, or in other words, no problems with the fuel flowing to the outside through the connecting hole 264b and the connecting passages 231b through the gap.

### E. Fifth Embodiment

(1) Structure of the Fuel Cut off Valve 200B

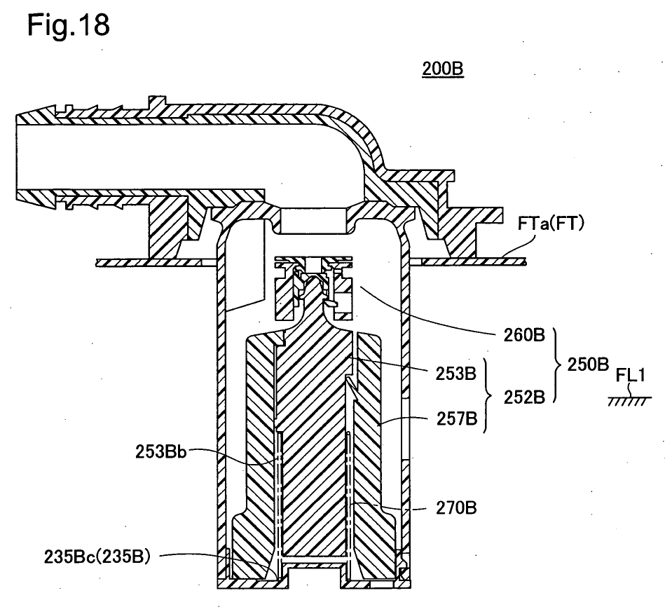

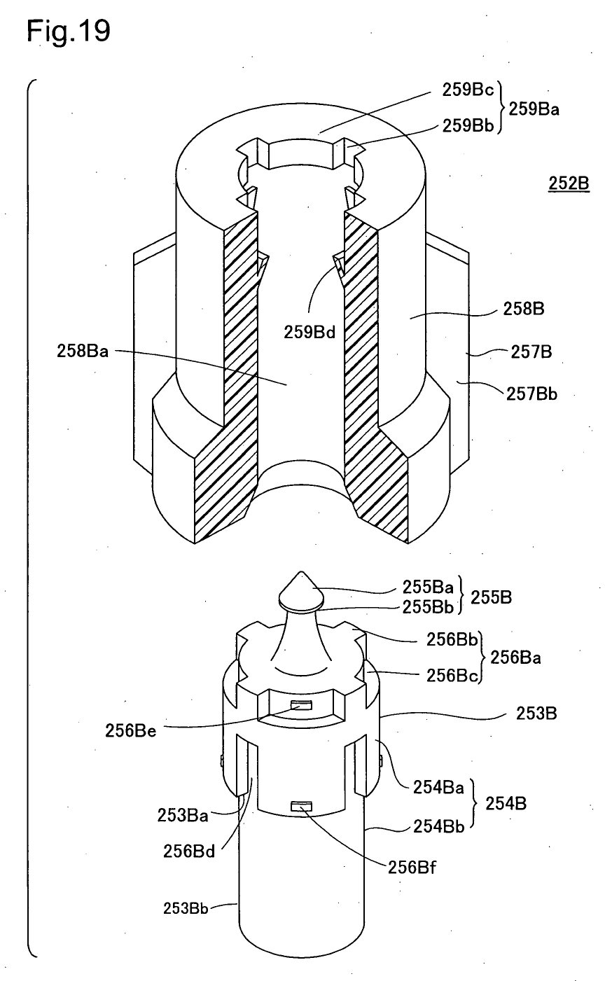

FIG. 18 is a cross-sectional view illustrating a fuel cut off valve 200B according to a fifth embodiment, and FIG. 19 is a prospective assembly view with a portion of the float mechanism 250B cut away. In FIG. 18, the float mechanism 250B is a two-stage valve structure with improved reopening performance, comprising a float 252B, and a valve mechanism 260B that is disposed at the upper part of the float 252B. The float 252B comprises a first float part 253B and a second float part 257B, which are assembled into a single unit. In FIG. 19, the first float part 253B comprises a first float main body 254B. The first float main body 234B comprises a large diameter part 254Ba and a small diameter part 254Bb, which extends below the large diameter part 254Ba, where these are integrally formed. A valve support part 255B is provided protruding at the upper part of the first float main body 254B. The valve support part 255B is a part that supports the valve mechanism 260 swivelably, and comprises a support protruding part 255Ba, which is an essentially cylindrical protrusion (protruding shape), where a ring-shaped protruding part 255Bb, for retaining the valve mechanism 260B, is formed at the outer peripheral part of the valve support part 255B. The step part between the large diameter part 254Ba and the small diameter part 254Bb, at the outer peripheral part of the first float main body 254B, is a spring support part 253Ba, and supports the top end of a spring 270B. As a shown in FIG. 18, the spring 270B is disposed in a spring housing gap 253Bb, which is a space between the first float part 253B and the second float part 257B.

The second float part 257B comprises a second float main unit 258B, which has a housing chamber 258Ba, which is cylindrical. Guide ribs 257Bb, for guiding the float 252 B in the upward and downward directions, are provided on the outer peripheral part of the second float part 257B, where the guide ribs 257Bb are provided protruding in the shape of ribs in the upward and downward directions in four locations, equally space around the outer periphery of these sidewalls.

Assembly means are provided for integrating the first float part 253B and the second float part 257B. That is, a mating part 256Ba is formed at the upper part of the first float part 253B. The mating part 256Ba is structured from mating protruding parts 256Bb and mating recess parts 256Bc, disposed alternatingly in the peripheral direction around the upper part of the first float main body 254B. Positioning grooves 256Bd are formed below each of the mating protruding parts 256Bb. Moreover, positioning step parts 256Be and 256Bf are provided protruding from the peripheral surface part of the large diameter part 254Ba and the bottom of the mating recess parts 256Bc, respectively, to increase the precision of the positioning by abutting a part of the second float part 257B.

On the other hand, the second float part 257B is provided with mating holes 259Ba, formed in shapes that are analogous to the mating part 256Ba of the first float 253. The mating hole 259Ba is provided with an arc wall 259Bc that makes with the mating recess 256Bc and constrains the movement of the second float part 256B in the upward direction. Moreover, mating claws 259Bd are equipped protruding on the wall surface of the housing chamber 258Ba. The mating claws 259Bd are provided protruding at an angle towards the central axis so as to mate with the top edge of the positioning groove 256Bd of the first float part 253B.

In assembling the first float part 253B to the second float part 257B, the mating part 256Ba is aligned with the mating hole 259Ba, and the first float part 253B is inserted into the housing chamber 258Ba of the second float part 257B. At this time, the outside surface of the mating part 256Ba pushes against and deflects the mating claws 259Bd. At this point, the mating claws 259Bd release their elastic force in the positioning grooves 256Bd, to mate with the top edge of the positioning groove 256Bd. In the state, the mating part 256Ba fits in the mating hole 259Ba, or, in other words, the mating protruding parts 256Bb mate with the mating recess parts 259Bb and the mating recess parts 256Bc mate with the arc wall 259Bc and, at the same time, the mating claws 259Bb are retained at the top edge of the positioning groove 256Bb to assemble into a single unit the first float part 253B and the second float part 257B. In the state, the spring housing gap 253Bb, which houses the spring 270B, is formed between the first float part 253B and the second float part 257B. (FIG. 18)

The fifth embodiment provides the following action and effects:

(2)-1: By structuring the float 252B from a plurality of members, comprising the first float part 253B and the second float part 257B, or in other words, by integrating the first float part 253B, on which the upper valve unit is held, with the second float part 257B, into a single unit, the buoyant force can be increased reliably by the volume of the second float part 257B.

(2)-2: The first float part 253B need not have the walls formed into a cup shape for increasing the buoyant force, but rather, when fabricating using injection molding, the surface sink in the valve support part 255B, which supports the upper valve unit, can be reduced, enabling an increase in molding precision.

(2)-3: In order to increase the buoyant force, in the float 252B, the first float part 253B and the second float part 257B can be assembled into a single unit to eliminate the sealed housing chamber 258Ba, thus making it possible to eliminate the variability in the buoyant force of the float 252B that accompanies changes in temperature and the sealed gases, enabling a repassageion in the variability of the closed-valve fluid level.

(2)-4: When fabricating the float 252B using resin injection molding and fabricating a space for housing in the spring 270B on the inside of the float 252B, as in the prior art, it is desirable to have the space be of a cylindrical shape that follows the outside shape of the spring 270B, and is slightly larger in order to reduce the size of the space as far as possible. However, not only is a narrow cylindrical mold required in order to fabricate such a space, but cooling means with fine cooling passages must also be provided in order to quickly cool the inside of the cylindrical mold, where such cooling means are difficult from the perspective of mold productivity. However, because the float 252B is formed from two members, the first float part 253B and the second float part 257B, in a structure that provides the spring housing gap 253Bb therebetween, there is no need for such a mold. In other words, the first float part 253B may be formed so as to emphasize the fabrication precision of, for example, the valve support part 255B, and the shape puts no constraints on the disposition of the cooling means. However, the second float part 257B may take into consideration, primarily, ways by which to increase the buoyant force and the shape for the disposition of the spring 270B, or in other words, neither of the members need to have shapes that require extended periods of time for cooling. This enables a reduction in the fabrication cycle time for injection molding, producing superior productivity.

(2)-5: In terms of the space for the disposition of the spring 270B, not only is the disposal structure simplified through the provision of the spring housing gap 253Bb between the first float part 253B and the second float part 257B, but this also eliminates the bulk that is required by the variation in buoyant force of the 252B, resulting from the changes in temperature. Furthermore, even if the fuel claims the spring housing gap 253Bb through capillary action, the fuel is quickly expelled from the spring housing gap 253Bb, so that there is no change in the apparent mass of the float 252B, so no change is caused in the closed-valve fluid level.

(2)-6: The second float part 257B is provided with a spring support part 253Ba for supporting one end of the spring 270B, so the load on the spring 270B is carried directly by the first float part 253B, and is not applied to the second float part 257B. Consequently, the size of the dimensional tolerance that occurs between the first float part 253B and the second float part 257B has no effect of increasing the play on the valve part at the upper part of the first float part 253B, which receives the load of the spring 270B, and thus does not cause a seal failure.

(2)-7: The first float part 253B and the second float part 257B are integrated into a single unit through mating means through the mating of the mating claws 259Bd and the positioning groove 256Bd, enabling a simplification of the assembly operations for the first float part 253B and the second float part 257B.

### F. Sixth Embodiment

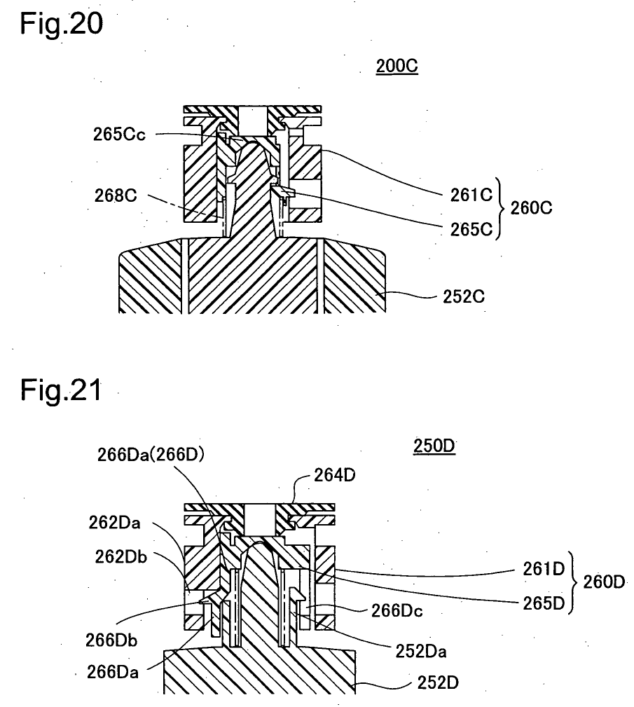

FIG. 20 is a cross-sectional view illustrating a sixth embodiment, a modification of the fifth embodiment. The present embodiment has the distinctive feature of being structured using a spring for supporting one part of the valve mechanism. A valve mechanism 260C comprises a first valve unit 261C and a second valve unit 265C, where the bottom end of the second valve unit 265C is supported by a spring 268C, which spanned between the second valve unit 265C and the top surface of a float 252C. The spring 268C applies a force to the second valve unit 265C in the direction that closes the valve, decreasing the likelihood of the second valve unit 265C separating from a second seat part 266Cc, even if the fine vibrations that occur due to the vibrations of the automobile, etc., were to reach the fuel cut off valve 200C, and so acts so as to prevent the second valve unit 265C from opening.

### G. Seventh Embodiment

FIG. 21 is a cross-sectional view the main parts of a fuel cut off valve according to a seventh embodiment. The float mechanism 250D of the present embodiment has the distinctive feature of the float 252D and the valve mechanism 260D being linked in the structure. Mating claws 252Da, for mating with the valve mechanism 260D, are provided protruding on the upper part of the float 252D. The valve mechanism 260D comprises a first valve unit 261D and a second valve unit 265D. Mating holes 266Db are formed in a cylindrical part 262Da of the first valve unit 261D. Retainer claws 266Db and mating holes 262Dc are formed in a cylindrical part 266Da of the second valve unit 265D. In the structure of the present embodiment, when the float 262D moves downward, the mating claw 252Da engages the mating hole 266D, pulling the second valve unit 265D downwards. When the float 252D moves downward interestedly with the second valve unit 265D, the retaining claw 266Db engages the mating hole 262Db to pull the first valve unit 261D downwards. The type of mating structure transfers the downward force of the float 252D to the first valve unit 261D and the second valve unit 265D.

### H. Eighth Embodiment

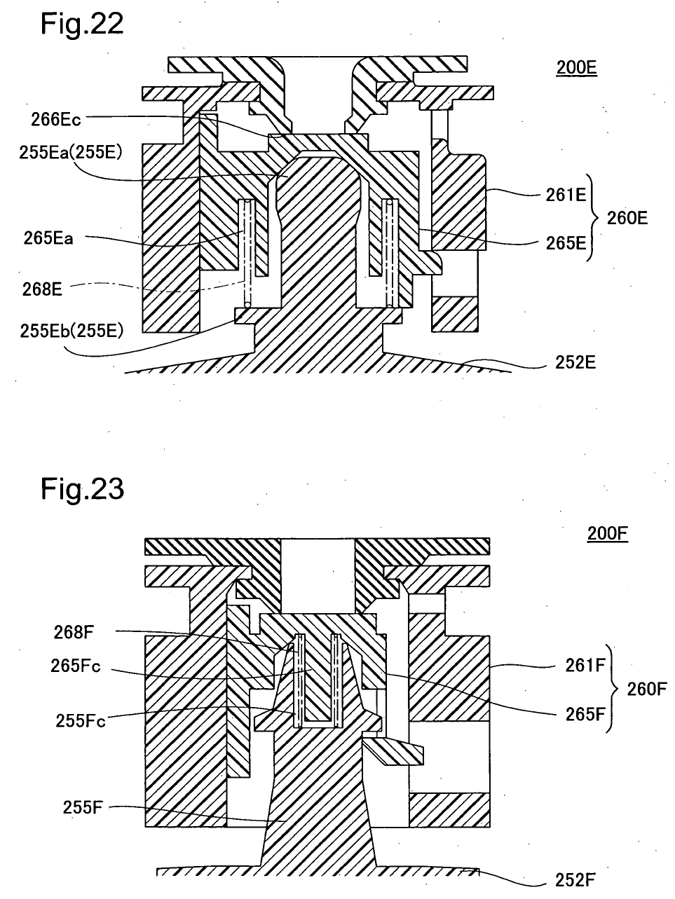

FIG. 22 is a cross-sectional view illustrating and eighth embodiment, an alternate form of the sixth embodiment. The present embodiment has the distinctive feature of the disposition and structure of the spring for supporting a part of the valve mechanism. The valve mechanism 260E comprises a first valve unit 261E and a second valve unit 265E, and is supported by a spring 268E that stretches between the bottom part of the second valve unit 265E and a valve support part 255E of a float 252E. In other words, the spring 268E is supported, on the bottom end thereof, on a ring-shaped protruding part 255Eb, that is formed on the bottom part of a valve support part 255E, and the top end thereof is supported on the bottom of a housing groove 265Ea that is formed in the second valve unit 265E, so that even if the fine vibrations that are caused by, for example, the vibrations of the vehicle, reach the fuel cut off valve 200E, the second valve unit 265E is not likely to become separated from the second seat part 266E, and thus these fine vibrations do not act to open the valve of the second valve unit 265E.

### J. Ninth Embodiment

FIG. 23 is a cross-sectional view illustrating a ninth embodiment, an alternate the eighth embodiment. The present embodiment has the distinctive feature of the disposition structure of the spring for supporting a portion of the valve mechanism. The valve mechanism 260F comprises a first valve unit 261F and a second valve unit 265F, and is supported by a spring 268F that spans between the bottom part of a second valve unit 265F and a valve support part 255F. In other words, a housing recess part 255Fc, for housing the spring 268 F, is formed facing the downward direction of the axle, from the top end of the valve support part 255F. One other hand, a protruding part 265Fc for preventing positional misalignment of the spring 268F is formed through inserting into the spring 268F from the bottom part of the second valve unit 265F.

### K. Tenth Example Embodiment

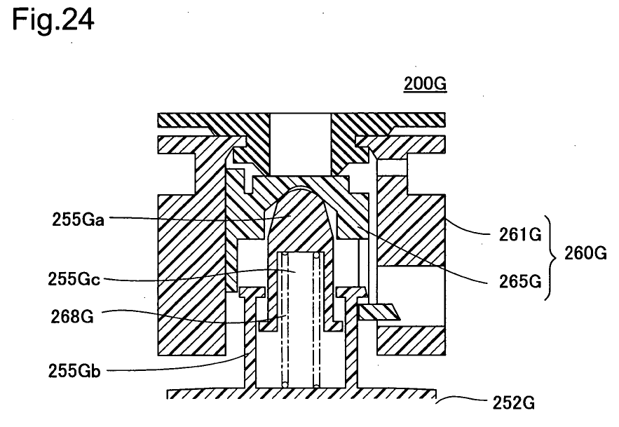

FIG. 24 is a cross-sectional view illustrating a tenth embodiment. The present embodiment has the distinctive feature of the support part and a spring for supporting a portion of the valve mechanism. A valve mechanism 260G comprises a first valve unit 261G and a second valve unit 265G, supported by a support part 255Ga, formed separately from the float 252G, and by a spring 268G. In other words, the support part 255Ga comprises a housing chamber 255Gc, which houses the spring 268G, facing upward from the bottom part thereof. The spring 268G is not only supported at the top surface of the float 252G, it also is housed within the housing chamber 255Gc and abuts the bottom part of the support part 255Ga so as to apply a force in the upward direction on the support part 255Ga to support the second valve unit 265G through the support part 255Ga. The support part 255Ga is held by the retainer part 255Gb that protrudes from the upper part of the float 252G.

Note that the present invention is not limited to the examples of embodiment described above, but rather can be embodied in a variety of forms in a range that does not deviate from the intent thereof, for example, the invention may be formed alternatively as follows:

(1) While in the examples of embodiment described above, guide ribs were formed on the outer peripheral part of the second valve unit, the present invention is not limited thereto, but rather the guide ribs may be formed on the inner walls of the supporting hole for the first valve unit.

(2) While in the examples of embodiment described above, the explanation was of a structure wherein the fuel cut off valve is installed on the upper surface of the upper wall of the a fuel tank, the present invention is not limited thereto, but rather may be of an in-tank type wherein the fuel cut off valve is installed on the inside surface of the top wall of the fuel tank.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A fuel cut off valve that is to be mounted on an upper portion of a fuel tank, for opening and closing a connecting passage that connects between an inside of the fuel tank and outside, the fuel cut off valve comprising:
a casing that forms a valve chamber that connects the inside of the fuel tank and the connecting passage; and
a float mechanism that is housed in the valve chamber and includes (i) a float that rises and falls by varying buoyant force according to a fuel level in the valve chamber and (ii) a valve mechanism that is disposed above an upper portion of the float and opens and closes the connecting passage through rising and falling of the float,
wherein the float includes a support part that is protruded from the upper portion of the float, the support part supporting the valve mechanism, and
the valve mechanism includes a supported part that is formed in a recess shape and supported on the support part, the valve mechanism being configured such that a center of gravity of the valve mechanism is set below a support portion where the support part supports the supported part under a balance,
wherein the valve mechanism further includes
a first valve unit having (i) a first valve main body, which has a first seat part that opens and closes the connecting passage and (ii) a connecting hole that is formed to pass through the first valve main body, an area of the connecting hole being smaller than that of the connecting passage; and
a second valve unit having (i) a second valve main body that is interposed between the first valve unit and the upper portion of the float and (ii) a second seat part that is disposed on the upper part of the second valve main body and opens and closes the connecting hole, a lower part of the second valve main body being configured to have the supported part.

2. The fuel cut off valve according to claim 1, wherein
the first valve main body is made of a resin material, and the first seat part is made of a rubber material, the first seat part being integrally formed with the first valve main body through insert molding.

3. The fuel cut off valve according to claim 1, wherein
the first valve main body includes a supporting hole that is connected to the connecting hole, and
the second valve main body that is housed to be able to rise and fall in the supporting hole,
the valve mechanism further comprises a guide rib that is disposed between an outer peripheral part of the second valve main body and an inside wall of the supporting hole, the guide rib being configured to guide the second valve main body in a vertical direction.

4. The fuel cut off valve according to claim 3, wherein the upper portion of the first valve main body comprises a ventilation hole that connects the supporting hole and the valve chamber.

5. The fuel cut off valve according to claim 3, further comprising a spring, disposed between the upper part of the float and the second valve unit, for applying a force to the second valve unit in the closing direction.

6. The fuel cut off valve according to claim 5, the second valve unit comprises a housing groove for housing the spring, the housing groove being configured to prevent the spring from coming in contact with the valve support part.

7. The fuel cut off valve according to claim 1, wherein the float comprises
a first float part that includes the support part and
a second float part that is attached to the first float part,
wherein the float includes a spring housing gap that is formed in a vertical direction between the first float part and the second float part, the spring housing gap storing a spring applies a force to the float.

8. The fuel cut off valve according to claim 7, wherein
the first float part includes a cylindrical first float main body, and
the second float part is a cylindrical shape and disposed so as to encompass an outer peripheral part of the first float part.

9. The fuel cut off valve according to claim 8, wherein the spring housing gap is connected to an outside part of the float.

10. The fuel cut off valve according to claim 1, further comprising a spring that is disposed between the upper portion of the float and the second valve unit and applies a force to the second valve unit in a closing direction.

11. The fuel cut off valve according to claim 10, the second valve unit comprises a housing groove for housing the spring, the housing groove being configured to prevent the spring from coming in contact with the valve support part.

12. The fuel cut off valve according to claim 10, wherein
the support part is formed separately from the float, and
the spring is supported on the upper portion of the float, and disposed so as to apply a force to the support part in the closing direction.

13. The fuel cut off valve according to claim 1, wherein the first valve main body comprises a cylindrical body, and the second valve main body comprises a cylindrical body housed in the first valve main body.

14. The fuel cut off valve according to claim 13, wherein the first valve main body extends downwardly such that a lower end of the first valve main body is disposed lower than a lower end of the second valve main body.

15. The fuel cut off valve according to claim 14, the first valve main body includes a mating hole, and the second valve main body includes a retaining claw engaging with the mating hole at an engaging position, the engaging position being set below the support portion.
